(19) United States
(12) Patent Application Publication
(10) Pub. No.: US 2023/0156175 A1
(43) Pub. Date: May 18, 2023

(54) AUTOSTEREOSCOPIC DISPLAY DEVICE AND METHOD

(71) Applicant: Tung-Chi Lee, Fongyuan City (TW)

(72) Inventor: Tung-Chi Lee, Fongyuan City (TW)

(21) Appl. No.: 17/657,501

(22) Filed: Mar. 31, 2022

(30) Foreign Application Priority Data
Nov. 18, 2021 (TW) 110142947

(51) Int. Cl. H04N 13/307; H04N 13/32; H04N 13/398

(52) U.S. Cl. CPC H04N 13/307; H04N 13/32; H04N 13/398

(57) ABSTRACT

An autostereoscopic display device and a method are provided. The autostereoscopic display device includes a display panel, a plurality of collimation units, and a plurality of refraction units. The display panel has a plurality of pixel groups, each of the pixel groups includes a plurality of pixels, all of the pixels are arranged in an array, and the display panel emits image light in a light-emitting direction. Each of the collimation units is located at one side of at least one pixel to receive the image light, and each of the collimation units converges the image light into collimated image light. Each of the refraction units is located in front of at least one pixel on two sides of a center of the pixel group, so as to receive the collimated image light and refract the collimated image light into refraction image light.

### CROSS-REFERENCE TO RELATED APPLICATION

This application claims priority from Taiwan Patent Application No. 110142947, filed on Nov. 18, 2021, in the Taiwan Intellectual Property Office, the content of which is hereby incorporated by reference in its entirety for all purposes.

### BACKGROUND OF THE INVENTION

### 1. FIELD OF THE INVENTION

The present disclosure relates to a display device, particularly to an autostereoscopic display device and a display method having an image panel, convex lens, and triangular prism with a predetermined configuration.

### 2. DESCRIPTION OF THE RELATED ART

Autostereoscopic (also known as Autostereoscopic 3D) display is a technology that allows users to see stereoscopic images without wearing special helmets or 3D glasses. In particular, parallax barriers, lenticular lenses, and directional backlight are the most common methods in the current autostereoscopic display technology.

FIG. 1 illustrates an exemplary display device using parallax barriers. Wherein, the parallax barriers 102 are disposed in front of the display panel 101. A group of alternating pixels can be seen only by a left eye, and the adjacent pixels which the left eye cannot see can be seen by a right eye. In the display device, the pixels seen by the left eye and those seen by the right eye form an image, which simulates stereoscopic vision. The technology of parallax barrier display is a simple method to realize autostereoscopic 3D display, but many drawbacks still can be found. One of the drawbacks is that the viewer must be situated in a pre-designed specific viewing region, and the viewing angle is restricted. Another drawback is that parallax barriers reduce brightness and resolution. Yet another drawback is that the viewer may experience crosstalk or overlap, wherein the right eye may see some of the images for the left eye; similarly, the left eye may also see some of the images for the right eye.

FIG. 2 illustrates another exemplary display device using lenticular lenses. Wherein, the lenticular lenses 202 are disposed in front of the display panel 201. The lenticular lenses guide the pixel light of the right eye and left eye to the appropriate viewpoint through refraction, and therefore the viewer can observe a single stereoscopic image. The brightness performance of the lenticular lenses is superior to that of the parallax barriers.

Although the brightness performance of the lenticular lenses is superior to that of the parallax barriers, both the parallax barriers and the lenticular lenses have the disadvantage of making a compromise between the resolution and the visual region. For example, it is assumed that the total number of pixels on the panel is N and the field of view is 1. The right eye is assigned N/2 pixels and the left eye is assigned N/2 pixels, so the viewer can only see N/2 resolution. When the display is designed as two visual regions, N/4 pixels are assigned to the right eye of the first region, and N/4 pixels are assigned to the right eye of the second region; the reset may be deduced in the same manner. Therefore, the viewer can only see N/4 resolution.

In view of what is mentioned above, the inventor of the present disclosure has designed an autostereoscopic display device and a method, in an effort to tackle deficiencies in the prior art and further to improve practical implementation in industries.

### SUMMARY OF THE INVENTION

The present disclosure aims to provide autostereoscopic display devices and related methods.

According to the purpose, the present disclosure provides an autostereoscopic display device, including a display panel, a plurality of collimation units, and a plurality of refraction units displayed in sequence along a light-emitting direction. The display panel has a plurality of pixel groups, each of the pixel groups includes a plurality of pixels, all of the pixels are arranged in an array, and the display panel emits image light in the light-emitting direction. Each of the collimation units is located at one side of at least one of the pixels to receive the image light, and each of the collimation units converges the image light into collimated image light and then emits the collimated image light along the light-emitting direction. Each of the refraction units is located in front of at least one of the pixels on two sides of a center of the pixel group, so as to receive the collimated image light; the refraction unit refracts the collimated image light into refraction image light and then emits the refraction image light along the light-emitting direction; wherein light beams of the refraction image light on two sides of the center of the pixel group are projecting in symmetrically increased oblique angles with respect to the center of the pixel group.

Preferably, the collimation unit is a convex lens, the refraction unit has an incident light surface and an emergent light surface, the incident light surface is a flat surface, is parallel to the display panel, and faces the display panel, and the emergent light surface is an inclined surface relative to the display panel.

Preferably, the collimation unit is a convex lens, the collimation unit has a first side and a second side relative to each other, the first side faces the display panel, the first side is a convex surface, and the second side is a flat surface.

Preferably, the collimation unit is located at one side of one of the pixels, the collimation unit has a first side and a second side relative to each other, the first side faces the display panel, the first side has a plurality of convex parts protruding to the display panel, the plurality of convex parts respectively correspond to a plurality of sub-pixels of the pixels, and the second side is a flat surface.

Preferably, the emergent light surface of the refraction unit on two sides of the center of the pixel group is disposed in a relatively oblique manner.

According to the purpose, the present disclosure also provides an autostereoscopic display method, including: providing a display panel, the display panel having a plurality of pixel groups, each of the pixel groups including a plurality of pixels, and all of the pixels being arranged in an array; controlling the pixels to emit corresponding image light according to coordinate information and depth information of an object in an image; disposing a plurality of collimation units on one side of the display panel to receive the image light and converge the image light into collimated image light and then emit the collimated image light along the light-emitting direction, and each of the collimation units being located on one side of at least one of the pixels; and disposing a plurality of refraction units on one side of the plurality of collimation units relative to the display panel, so as to receive the collimated image light and refract the collimated image light into refraction image light, which is then emitted along the light-emitting direction, and each of the refraction units being located in front of at least one of the pixels on two sides of a center of the pixel group; wherein light beams of the refraction image light on two sides of the center of the pixel group are projecting in symmetrically increased oblique angles with respect to the center of the pixel group.

Preferably, the method further includes: disposing an incident light surface of the refraction unit to be a flat surface, be parallel to the display panel, and face the display panel; disposing an emergent light surface of the refraction unit to be an inclined surface relative to the display panel; and disposing the emergent light surface of the refraction unit on two sides of the center of the pixel group in a relatively oblique manner.

Preferably, the method further includes: disposing a convex lens to be the collimation unit, and the collimation unit having a first side and a second side relative to each other; and making the first side face the display panel, wherein the first side is a convex surface, and the second side is a flat surface.

Preferably, the method further includes: disposing one of the collimation units to be located on one side of one of the pixels, and the collimation unit having a first side and a second side relative to each other; and making the first side face the display panel, wherein the first side has a plurality of convex parts protruding to the display panel, each of the convex parts corresponds to a plurality of sub-pixels of one of the pixels, and the second side is a flat surface.

Preferably, in the autostereoscopic display device or the autostereoscopic display method, the center of the pixel group has a normal line, and an included angle between the inclined surface and the normal line is gradually reduced from the center of the pixel group to two sides of the center of the pixel group.

Preferably, in the autostereoscopic display device or the autostereoscopic display method, the light beams of the refraction image light on two sides of the center of the pixel group are symmetrically and obliquely diffused.

Preferably, in the autostereoscopic display device or the autostereoscopic display method, one of the collimation units and one of the refraction units are integrated into an integrally-formed module.

The technical features of the present disclosure are to be illustrated in detail below with specific embodiments and accompanying drawings to make a person with ordinary skill in the art effortlessly understand the purpose, technical features, and advantages of the present disclosure.

### BRIEF DESCRIPTION OF THE DRAWINGS

The drawings required for the description of the embodiments of the present disclosure are to be briefly described below to illustrate more clearly the technical solutions of the embodiments of the present disclosure. It is obvious that the accompanying drawings described below are only some embodiments of the present disclosure. For a person with ordinary skill in the art, additional drawings can be obtained according to these drawings.

FIG. 1 is a schematic diagram of an embodiment of the autostereoscopic display device in the prior art.

FIG. 2 is a schematic diagram of another embodiment of the autostereoscopic display device in the prior art.

FIG. 3A and FIG. 3B are the first schematic diagrams of the technical description of the autostereoscopic display device.

FIG. 4A and FIG. 4B are the first schematic diagrams of the autostereoscopic display device in the present disclosure.

FIG. 5A and FIG. 5B are the second schematic diagrams of the technical description of the autostereoscopic display device in the present disclosure.

FIG. 6 is the second schematic diagram of the autostereoscopic stereoscopic display device in the present disclosure.

FIG. 7 is the third schematic diagram of the autostereoscopic stereoscopic display device in the present disclosure.

FIG. 8 is the fourth schematic diagram of the autostereoscopic stereoscopic display device in the present disclosure.

FIG. 9 is the fifth schematic diagram of the autostereoscopic stereoscopic display device in the present disclosure.

FIG. 10 is the sixth schematic diagram of the autostereoscopic stereoscopic display device in the present disclosure.

FIG. 11A and FIG. 11B are the seventh schematic diagrams of the autostereoscopic display device in the present disclosure.

FIG. 12 is the eighth schematic diagram of the autostereoscopic stereoscopic display device in the present disclosure.

FIG. 13 is the ninth schematic diagram of the autostereoscopic stereoscopic display device in the present disclosure.

FIG. 14A and FIG. 14B are the tenth schematic diagrams of the autostereoscopic display device in the present disclosure.

FIG. 15A and FIG. 15B are schematic diagrams of another embodiment of the autostereoscopic display device in the present disclosure.

FIG. 16A is a schematic diagram of yet another embodiment of the autostereoscopic display device in the present disclosure.

FIG. 16B is a schematic diagram of still another embodiment of the autostereoscopic display device in the present disclosure.

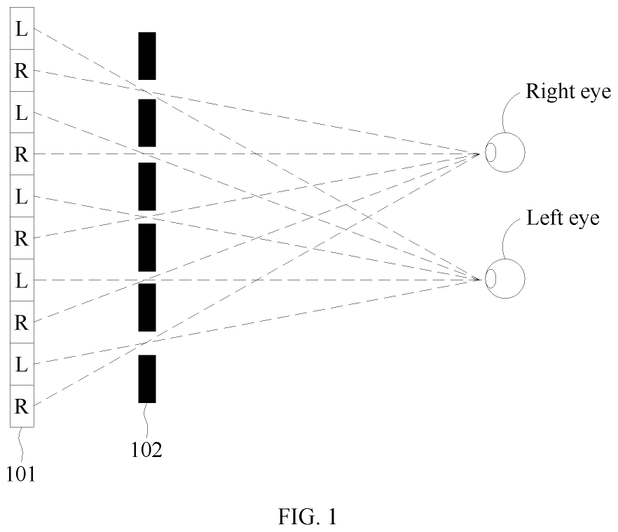

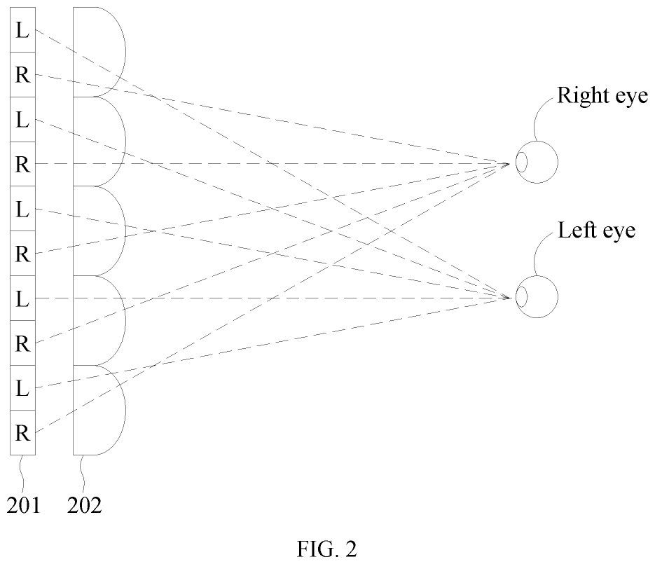

### DESCRIPTION OF THE PREFERRED EMBODIMENTS

The advantages, features, and technical methods of the present disclosure are to be explained in detail with reference to the exemplary embodiments and the figures for the purpose of being easier to be understood. Moreover, the present disclosure may be realized in different forms, and should not be construed as being limited to the embodiments set forth herein. Conversely, for a person with ordinary skill in the art, the embodiments provided shall make the present disclosure convey the scope more thoroughly, comprehensively, and completely. In addition, the present disclosure shall be defined only by the appended claims.

It should be noted that although the terms “first,” “second,” and the like may be used in the present disclosure to describe various elements, components, regions, sections, layers, and/or parts, these elements, components, regions, sections, layers and/or parts should not be limited by these terms. These terms are only used to distinguish one element, component, region, sections, layer, and/or part from another element, component, region, sections, layer, and/or part.

Unless otherwise defined, all terms (including technical and scientific terms) used in the present disclosure have the same meaning as those commonly understood by a person with ordinary skill in the art. It should be further understood that, unless explicitly defined herein, the terms such as those defined in commonly used dictionaries should be interpreted as having definitions consistent with their meaning in the context of the related art and the present disclosure, and should not be construed as idealized or overly formal.

Whether the object is luminous or illuminated by other light sources, the light field is the vector of light emitted from the object. Wherein, the light field describes all the image information of the real object, including the position, direction, color, and intensity of the light. The purpose of the autostereoscopic display device is to emit light from the image in a dedicated direction according to the image position and depth clue and simulate the light field of a real object. This allows the viewer to see a stereoscopic image in virtual reality without being restricted to a limited visual field.

The present disclosure provides an autostereoscopic display device, including a display panel, a plurality of collimation units, and a plurality of refraction units displayed in sequence along a light-emitting direction. The display panel has a plurality of pixel groups, each of the pixel groups includes a plurality of pixels, all of the pixels are arranged in an array, and the display panel emits image light in the light-emitting direction. Each of the collimation units is located at one side of at least one of the pixels to receive the image light, and each of the collimation units converges the image light into collimated image light and then emits the collimated image light along the light-emitting direction. Each of the refraction units is located in front of at least one of the pixels on two sides of a center of the pixel group, so as to receive the collimated image light; the refraction unit refracts the collimated image light into refraction image light and then emits the refraction image light along the light-emitting direction; wherein light beams of the refraction image light on two sides of the center of the pixel group are projecting in symmetrically increased oblique angles with respect to the center of the pixel group.

The aforementioned description is to be further illustrated in detail below.

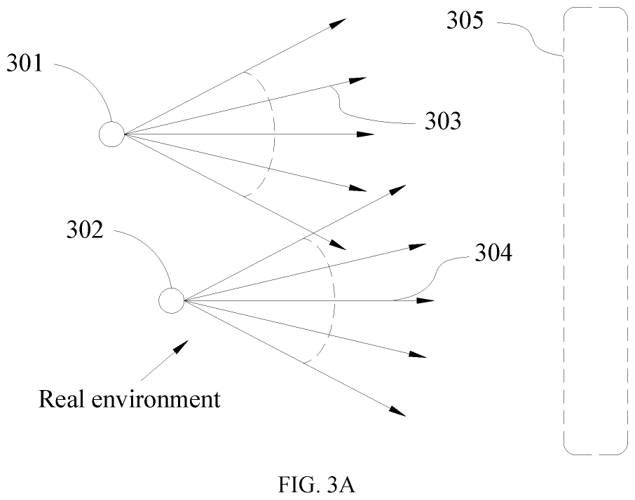

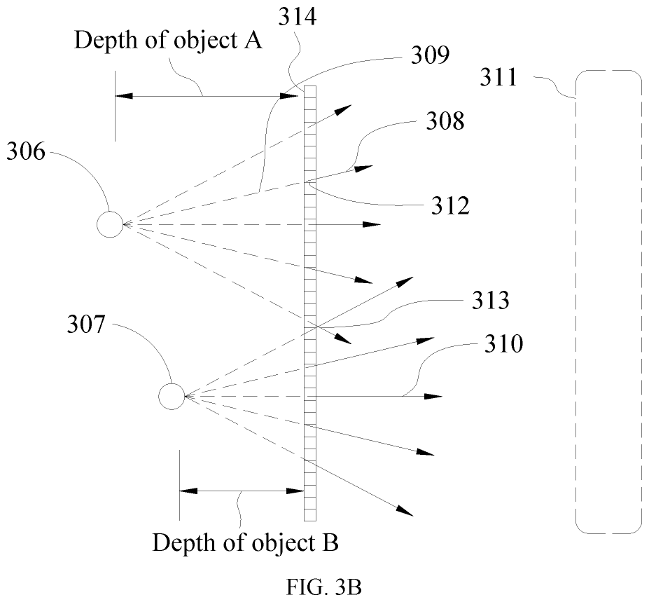

Please refer to FIG. 3A and FIG. 3B. As shown in FIG. 3A, the light 303 and light 304 respectively represent the light fields of object A 301 and object B 302. A stereo camera is positioned in the shooting visual region 305 to record or shoot stereoscopic images corresponding to object A 301 and object B 302. Next, the image processor of the display device may extract the relative position and depth relationship of object A 301 and object B 302 from the stereoscopic images corresponding to object A 301 and object B 302. As shown in FIG. 3B, the autostereoscopic display panel 314 includes a plurality of pixel groups, and a collimation unit as a convex lens and a refraction unit as a triangular prism are provided in front of each of the pixel groups (i.e. between the autostereoscopic display panel 314 and the viewing visual region 311). Wherein, the autostereoscopic display panel may reproduce the light fields of the image 306 of object A and the image 307 of object B for the viewing visual region 311 based on the relative position and depth relationship. For example, the pixel group 312 emits light 308 along a straight line from the image 306 of object A to the pixel group 312, and the pixel group 313 emits light from the image 306 of object A and the image 307 of object B at the same time; all the pixel groups may be deduced in the same manner. Therefore, all viewers in the viewing visual region 311 may observe the simulated light fields of object A and object B without being restricted to a small viewing region. However, the light field 303 of object A 301 is continuous around object A 301, whereas the light emitted from the pixel 308 is finite and discrete; the quality of the stereoscopic display depends on the panel resolution, that is, the pixel density of the display panel.

It should be noted that two-dimensional display devices are the most popular display devices on the market, including liquid crystal display (LCD) panel, light-emitting diode (LED) array, organic light-emitting diode (OLED) display, and screen projection. Owing to the advancement of modern display technology, display devices with larger sizes and higher pixel density constantly appear on the market. Therefore, the higher pixel density suggests that it is feasible to construct an autostereoscopic display device by using rich pixels. In the present disclosure, the refraction principle is used to redirect light to a specific direction; a further explanation is exemplified hereinafter.

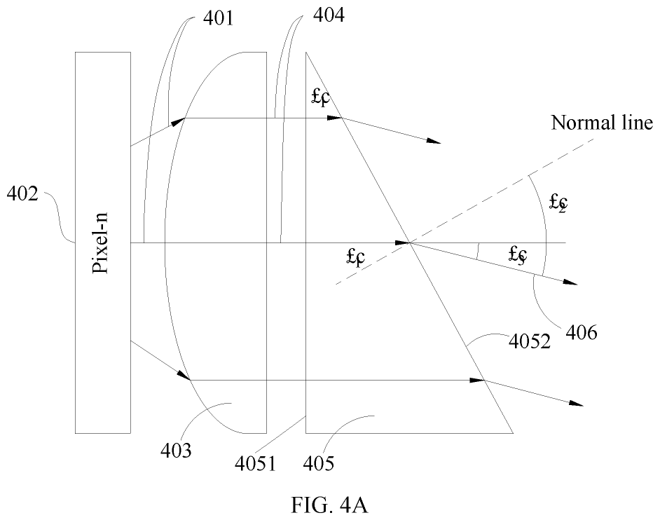

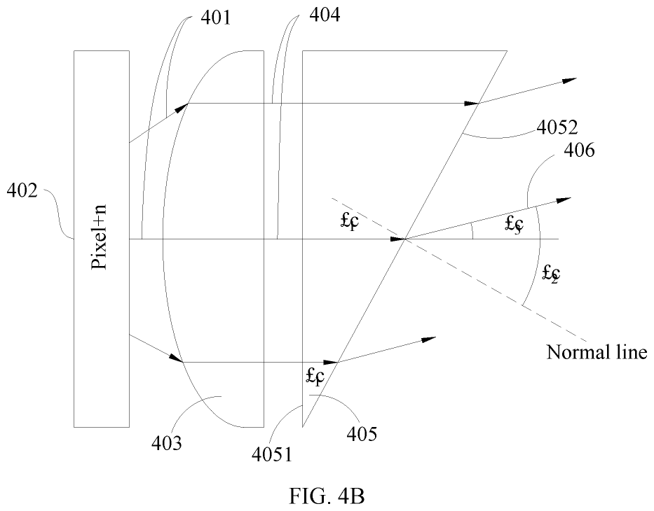

Please refer to FIG. 4A and FIG. 4B, which are the first schematic diagrams of the autostereoscopic display device in the present disclosure. As shown in the figures, the display panel has a plurality of pixel groups, and each of the pixel groups includes a plurality of pixels 402; in FIG. 4A and FIG. 4B, the display panel and the pixel groups thereof are omitted for the convenience of description, which is to be explained later. As shown in FIGS. 4A and 4B , the refraction unit 405 has an incident light surface and an emergent light surface, the incident light surface is flat and faces the display panel while being parallel to the display panel, the emergent light surface is an inclined surface relative to the display panel. Wherein, the light (image light) 401 emitted from the pixel 402 is converged into collimated image light 404 through the collimation unit 403 as a convex lens. The collimated image light 404 passes perpendicularly through the incident light surface 4051 of the refraction unit 405 as a triangular prism into the refraction unit 405. The collimated image light 404 is refracted into the refraction image light 406 through the emergent light surface 4052 of the refraction unit 405. Wherein, the refraction image light 406 on both sides of the center of the pixel group diffuse outward and are distributed in a symmetrical oblique direction.

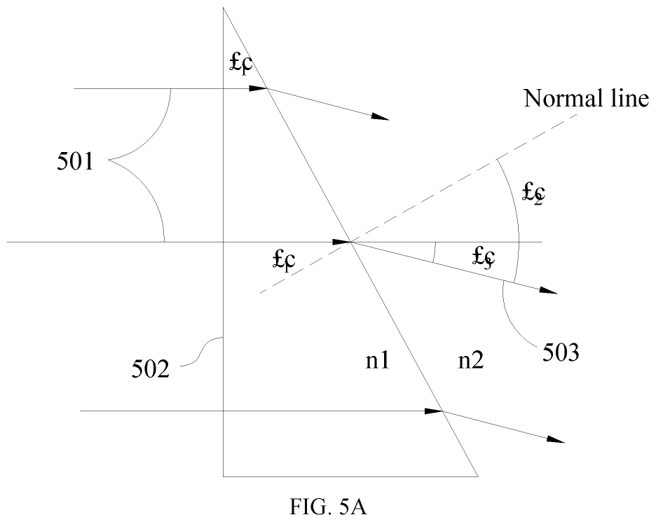

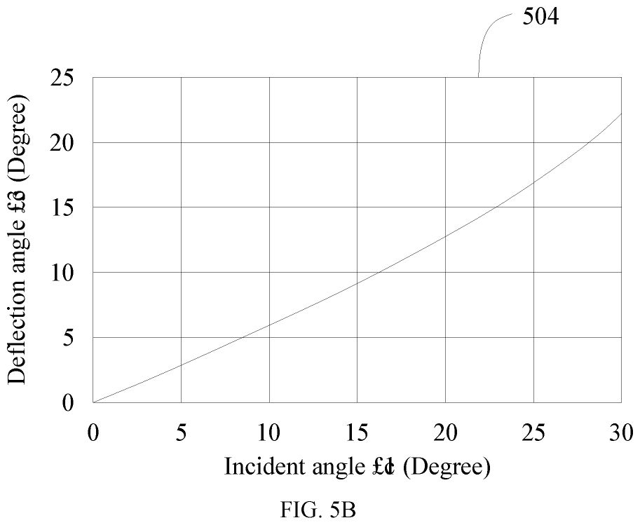

Please refer to FIG. 5A and FIG. 5B. The relationship between the incident angle θ₁ and the deflection angle θ₃ is shown in FIG. 5A. The refraction angle θ₂ may be calculated using Snell's Law, sinθ₁: sinθ₂=n2: n1. n1 is the refractive index of the material of the refraction unit 502. It is assumed that the material of the refraction unit 502 as a triangular prism is polyethylene terephthalate (PET), and n1 is 1.58. n2 is the refractive index of the atmosphere, which is equal to 1. The deflection angle ₃ is the included angle between the emergent light 503 and the incident light 501, which is equal to the difference between 0₁ and 0₂. The relationship between 0₃ and 0₁ is calculated and shown in the table of FIG. 5B.

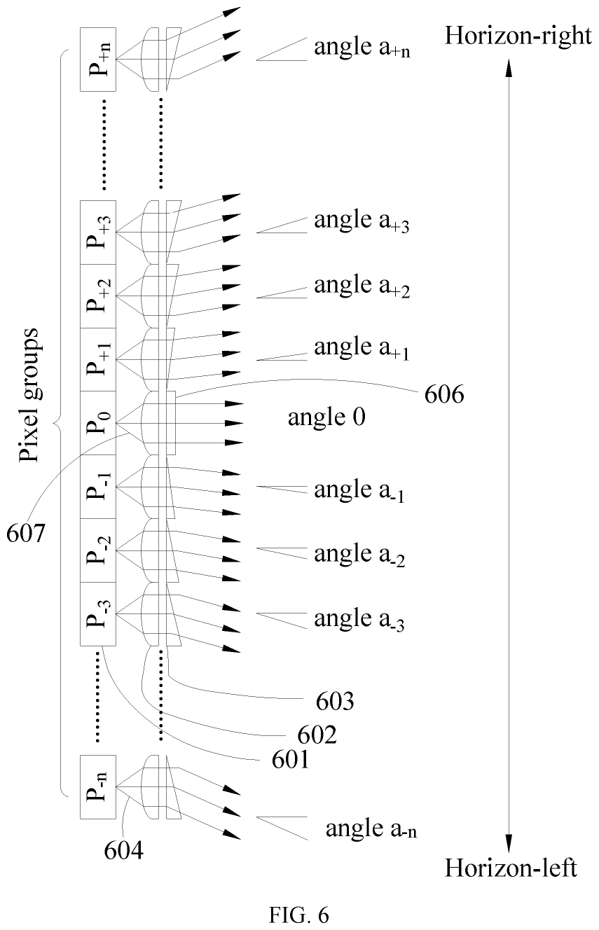

FIG. 6 is a schematic planar graph of the pixel group arrangement in the exemplary embodiment. For clarity, only a small portion of the pixel group is shown in the figure. A pixel group is formed of 2n+1 pixels 601, n being a positive integer; except for the central pixel P₀, each pixel is equipped with a collimation unit 602 as a convex lens and a refraction unit 603 as a triangular prism. The pixels in a pixel group are numbered in ascending order from −n to +n, labeled as P₋ₙ to P₊ₙ. For the pixel P₀, the light (image light) 607 emitted from the pixels is converged by the collimation unit 602 into collimated image light, which passes through the rectangular prism 606 without refraction. For the pixels Pₙ to P₊ₙ other than the pixel P₀, the light 604 emitted from the pixels is converged by the collimation unit 602 into collimated image light, which is then refracted by the refraction unit 603; the deflection angles are from a to a₊ₙ arranged in an angularly symmetrical manner; that is, the angle an is equal to the negative value of the angle a₊ₙ. The angle sequence a₊₁, a₊₂, . . . , a₊ₙ is designed as an increasing sequence, and the angle difference between continuous items need not be constant.

That is, the emergent light surface of the refraction unit 603 on two sides of the center of the pixel group is disposed in a relatively oblique manner; furthermore, the center of the pixel group has a normal line, and an included angle between the inclined surface and the normal line is gradually reduced from the center of the pixel group to two sides of the center of the pixel group.

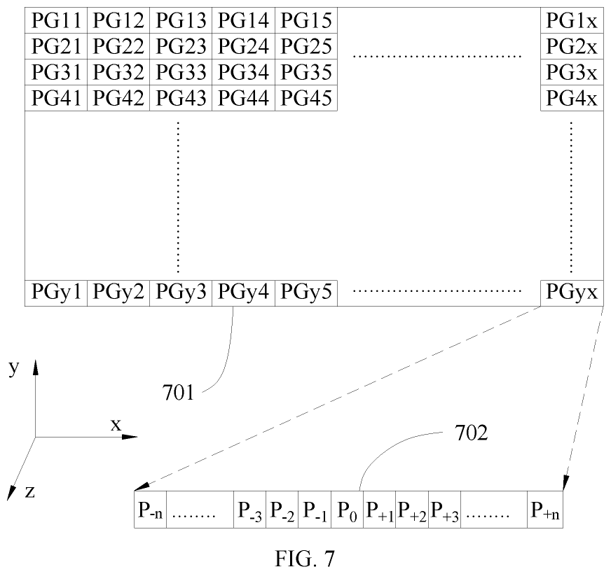

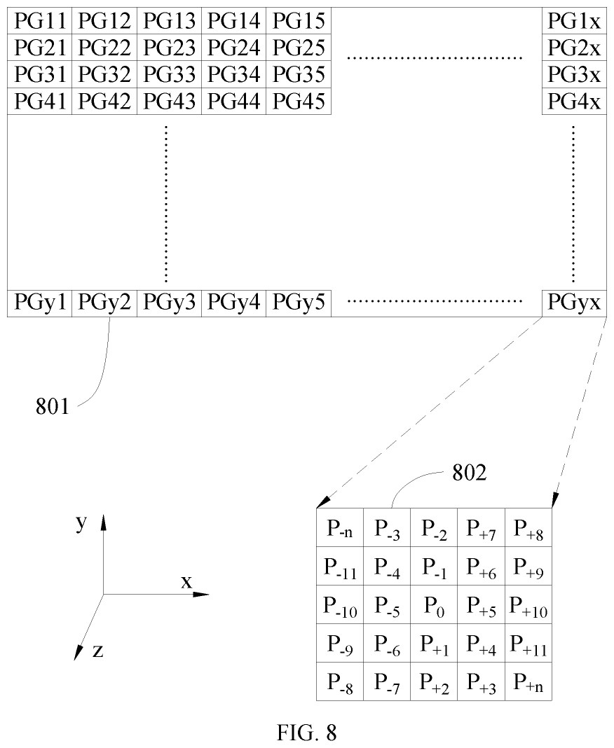

Please refer to FIG. 7 as well as FIG. 8. FIG. 7 is a schematic diagram illustrating the pixels in a pixel group arranged in columns. FIG. 8 is a block diagram illustrating the pixels in a pixel group arranged in a checkerboard manner. As shown in FIG. 7, the pixels in the pixel group 702 may be arranged in a linear or checkerboard manner. The display panel 701 is formed of an array of the pixel group arranged in X rows and Y columns. The pixels in a pixel group are arranged in a linear manner. As shown in FIG. 8, the display panel 801 is formed of an array of the pixel group 802, with the pixel group arranged in X rows and Y columns; wherein, the pixels in the pixel group are arranged in a checkerboard manner.

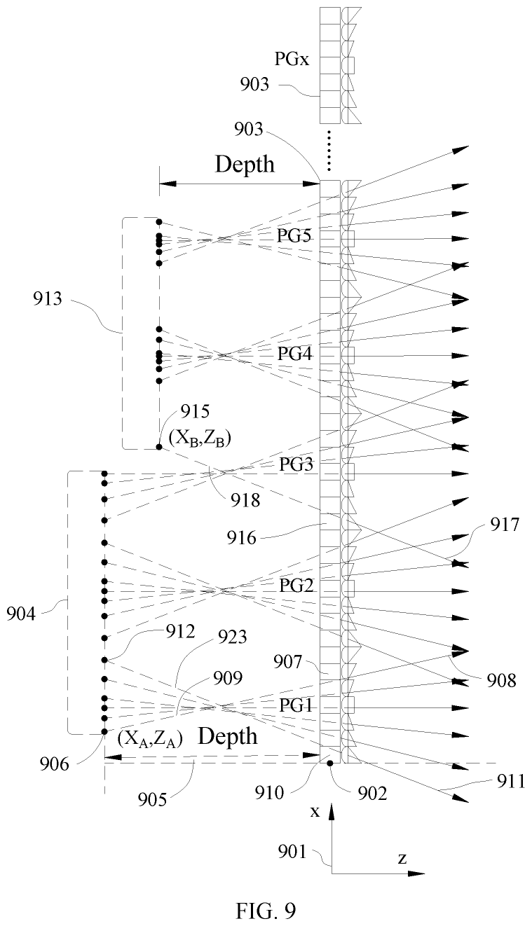

Please refer to FIG. 9, which is a schematic diagram depicting the relationship between object images and pixel data. For clarity, the number of pixels in a pixel group is only set to 7, which should not be limited thereto, however. In addition, only two objects and a small portion of pixel groups are illustrated exemplarily in the figure. The coordinates 901 and the original point 902 show the coordinates in the figure, with positive z being the direction toward the front of the display panel 903 and negative z being the direction toward the back of display panel 903. The size, location, and depth clue of image A 904 and image B 913 may be extracted from the input stereoscopic image using the image processor not depicted in the figure. The coordinate position of image A 904 are x_{A}, z_{A} (as indicated by the symbol 906), wherein z_{A} indicates the depth of object A to which image A corresponds. Light 911 is emitted from the pixel 910 at a specific angle (angle of a₋₃ as shown in FIG. 6). According to all the data including the position of the pixel 910, the light angle (such as the angle of a₋₃ as shown in FIG. 6), and the size and coordinates of image A 904, the image processor may calculate the intersection point 912 of the extension line 923 of light 911 and image A 904. Thus, the data of the intersection point 912 of image A 904 may correspond to the pixel 910, which in turn makes the pixel 910 emit a corresponding light field (image light). Likewise, the image processor may calculate the intersection point 906 of the extension line 909 of the light 908 emitted from the pixel 907 and image A 904, and hence the data of the intersection point 906 of image A 904 may correspond to the pixel 907, which in turn makes the pixel 907 emit a corresponding light field (image light). The coordinate position of image B 913 is x_{B}, z_{B} (as indicated by symbol 915), and z_{B} is equal to the depth of object B to which image B 913 corresponds. Likewise, the extension line 918 of the light 917 emitted from the pixel 916 has an intersection point 915 with image B 913, and therefore the data of the intersection point 915 may correspond to the pixel 916, which in turn makes the pixel 916 emit a corresponding light field (image light). The rest of the pixels are also deduced in the same manner, so similar descriptions are not to be described herein.

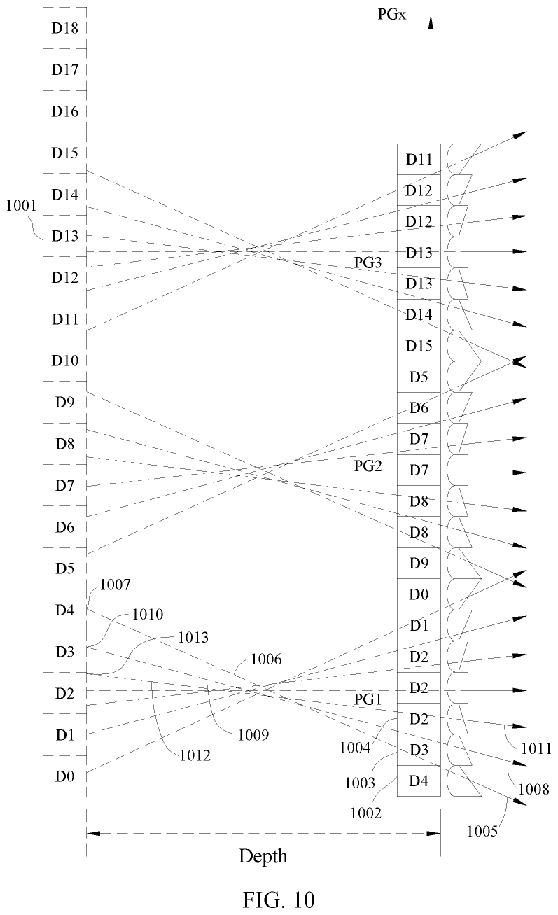

Please refer to FIG. 10, which is a description of the output image data; for clarity, only a small portion of the pixels are shown in the figure. The extension line 1006 of the light 1005 intersects with the image 1001 at the intersection point 1007, and then the data D4 of the intersection point 1007 is written into or corresponds to the pixel 1002. Similarly, the extension line 1009 of the light 1008 intersects with the image 1001 at the intersection point 1010, and therefore the data D3 at the intersection point 1010 is written or corresponds to the pixel 1003; the extension line 1012 of the light 1011 intersects with the image 1001 at the intersection point 1013, and therefore the data D2 at the intersection point 1013 is written or corresponds to the pixel 1004. The rest of the pixels are also deduced in the same manner, so similar descriptions are not to be described herein.

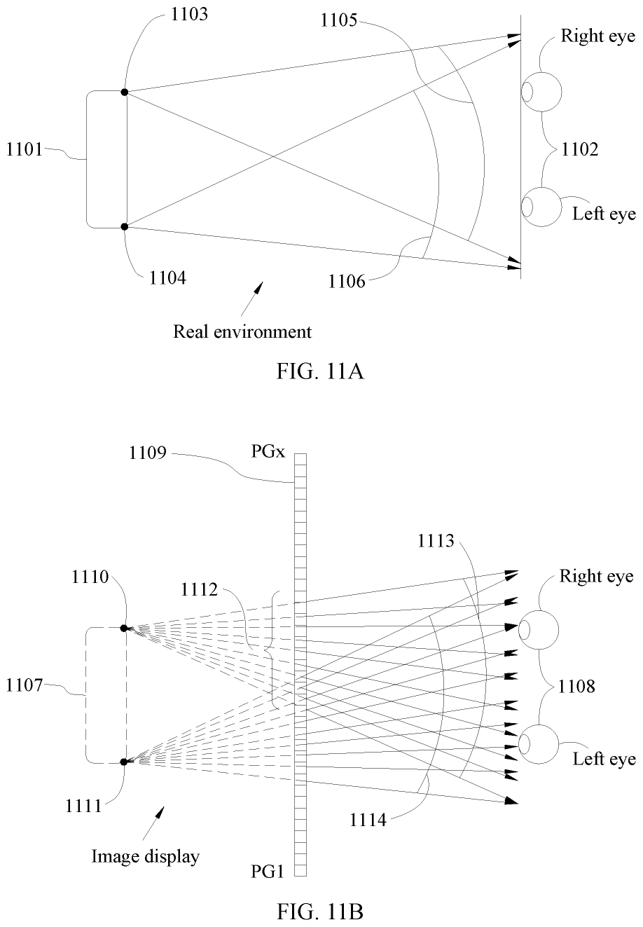

Please refer to FIG. 11A and FIG. 11B, which are schematic diagrams indicating the comparison between the light fields of the real object and the image display. As shown in FIG. 11A, with regard to the real environment, regardless of whether the object is luminous or illuminated by other light sources, the light field 1105 is formed of light emitted from the point 1103 of the object 1101, and the light field 1106 is formed of light emitted from the point 1104 of the object 1101. Moreover, the light field is continuous in all directions. The viewer 1102 may observe the light fields 1105 and 1106 and identify the position and direction of the object 1101. Regarding the image display, the display panel 1109 includes a plurality of pixel groups labeled as PG1 to PGx. According to the process described in FIG. 9, as shown in FIG. 11B, the image 1107 data may be written into the pixels on the display panel 1109. The image data of the point 1110 may be written into the pixels where the light beam is directed toward the point 1110. It is assumed that all pixels with the point 1110 are within the range 1112 of the pixel groups, and the light 1113 is emitted from these pixels. The light 1113 includes information about the image data, direction, and positional relationship of the point 1110 of the image 1107, and the light 1114 also further includes information about the image data, direction, and positional relationship of the point 1111. Therefore, the light 1113 and light 1114 may be equivalent to light fields 1105 and 1106. The only difference is that the light fields 1105 and 1106 are continuous fields, whereas the light 1113 and light 1114 are formed of a plurality of light beams and are discrete. As the density of pixel groups in the panel increases and the number of pixels in each pixel group increases, the beam density of the light 1113 and light 1114 may also increase and the quality of the stereoscopic image may be significantly improved.

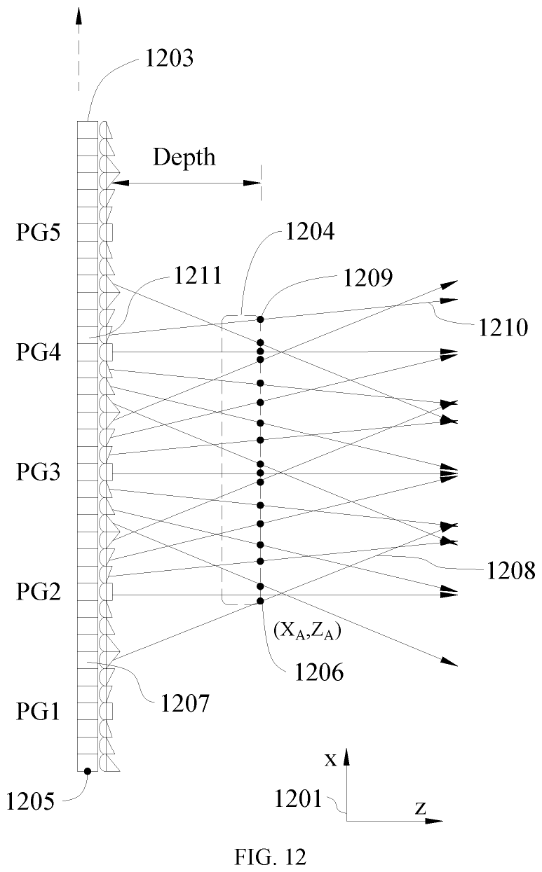

Please refer to FIG. 12. If the image is in front of the panel, the viewer may feel that the image is outside the screen. The process of displaying an image in front of the panel is shown in FIG. 12, similar to the process shown in FIG. 9. FIG. 12 is a planar graph of the image display process, where the number of pixels in a pixel group is set to 7 only; for clarity, only a small portion of pixel groups are shown in the figure. The coordinates 1201 and the original point indicate the coordinates in FIG. 12, and positive z is the direction showing the front of the display panel 1203. Information about the size, position, and depth relationship of the image 1204 of the object may be extracted from the input stereoscopic image by the image processor (not shown in the figure). The coordinates of the image 1204 are x_{A}, z_{A} (marked by symbol 1206), wherein z_{A} is the distance from the image 1204 to the display panel 1203. The light 1208 is emitted from the pixel 1207 at a specific angle a₊₃ (as shown in FIG. 6). Based on all the data including the position of the pixel 1207, the light angle a₊₃, and the size and coordinates of the image 1204, the image processor may calculate the intersection point 1206 of the light 1208 and the image 1204.

Therefore, the data of the image 1204 is written into the pixel 1207, which in turn makes the pixel 1207 emit a corresponding light field (image light). Similarly, the light 1210 of the pixel 1211 may intersect with the image 1204 at the intersection point 1209, and then the data of the intersection point 1209 may be written into the pixel 1211. This process is then applied to all pixels so that all pixels emit corresponding light fields (image light).

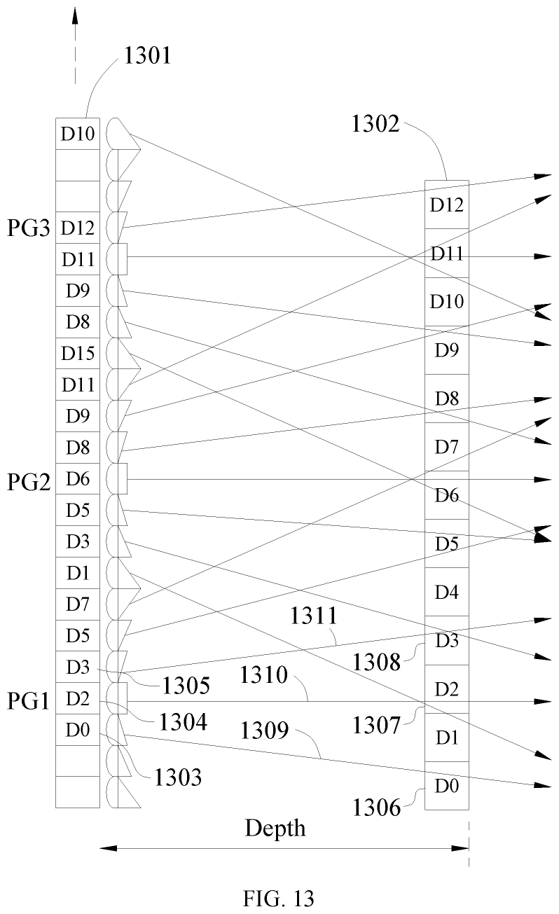

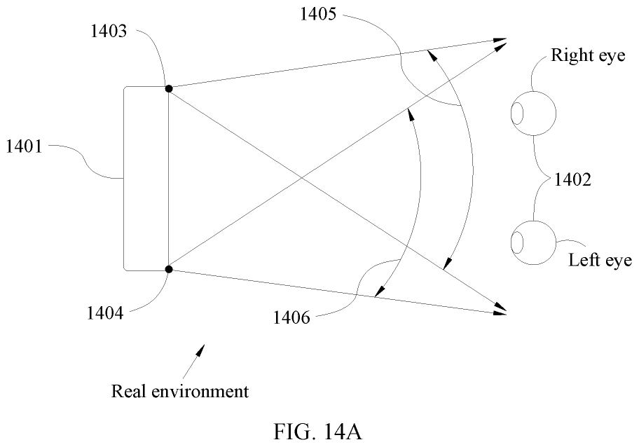

Please refer to FIG. 13. FIG. 13 is a detailed description of the image data applied to the output; for clarity, only a small portion of the pixels are shown in the figure. The light 1309 intersects with the image 1302 at the intersection point 1306, and then the data D0 of the intersection point 1306 may be written into the pixel 1303. Similarly, the data D2 of the intersection point 1307 may be written into the pixel 1304, and the data D3 of the intersection point 1308 may be written into the pixel 1305, etc. This process is then applied to all pixels so that all pixels emit corresponding light fields (image light).

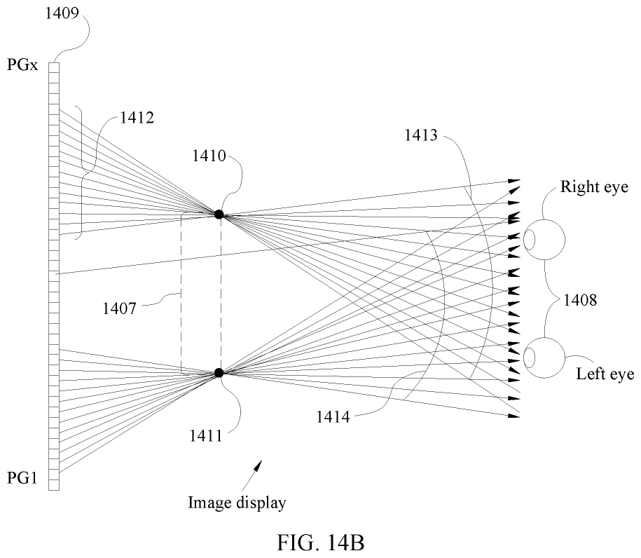

Please refer to FIG. 14A and FIG. 14B. FIG. 14A and FIG. 14B are schematic diagrams indicating the comparison between the light fields of the real object and the image display. As shown in FIG. 14A, with regard to the real environment, regardless of whether the object is luminous or illuminated by other light sources, the light field 1405 is formed of light emitted from the point 1403 of the object 1401, and the light field 1406 is formed of light emitted from the point 1404 of the object 1401. The light field is continuous in all directions. The viewer 1402 may observe the light fields 1405 and 1406 and identify the position and direction of the object 1401. Regarding the image display, the display panel 1409 includes a plurality of pixel groups labeled as PG1 to PGx. The data of the image 1407 may be written into the pixels on the display panel 1409 by the process described below and in FIG. 12. The image data of the point 1410 of the image 1407 may be written into the (corresponding) pixels where the light is directed toward the point 1410. It is assumed that all pixels with the point 1410 are within the range 1412 of the pixel groups, and the light 1413 is emitted from these pixels. The light 1413 includes information about the image data, direction, and positional relationship of the point 1410 of the image 1407, and the light 1414 also further includes information about the image data, direction, and positional relationship of the point 1411. Therefore, the light 1413 and light 1414 may be equivalent to light fields 1405 and 1406. The only difference is that the light fields 1405 and 1406 are continuous fields, whereas the light 1413 and light 1414 are formed of a plurality of light beams and are discrete. As the density of pixel groups in the display panel 1409 increases and the number of pixels in each pixel group increases, the beam density of the light 1413 and light 1414 may also increase. Therefore, the autostereoscopic display may be improved from the side of the viewer 1408.

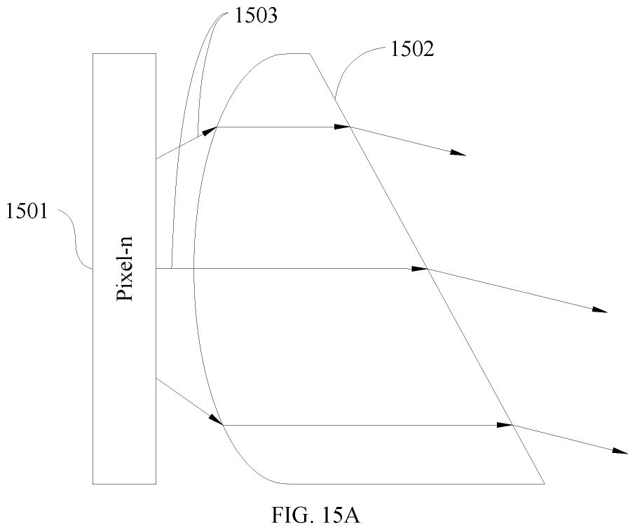

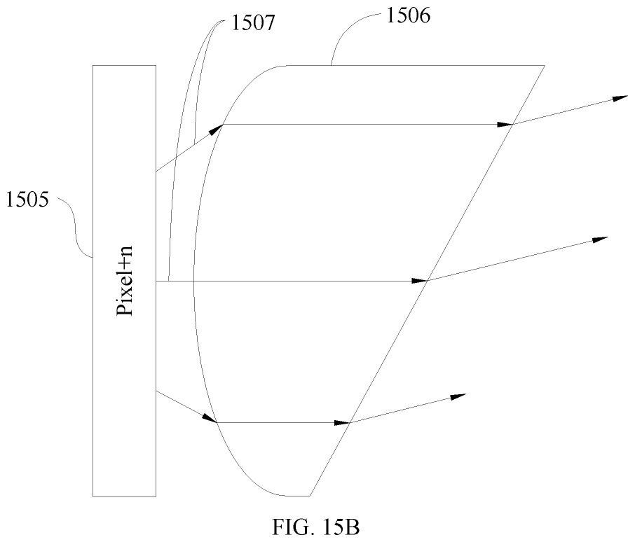

Please refer to FIG. 4 together with FIG. 15A and FIG. 15B. The collimation unit 401 as a convex lens and the refraction unit 405 as a triangular prism as shown in FIG. 4 may be combined into an optical module (i.e., as shown in FIG. 15A and FIG. 15B); that is, the collimation unit 401 and the refraction unit 405 are made in an integrally-formed manner. FIG. 15A and FIG. 15B are schematic diagrams of the optical module. The optical module 1502 and the optical module 1506 are optical modules made in an integrally-formed manner based on the collimation unit 401 as a convex lens and the refraction unit 405 as a triangular prism, which may have the same optical function as the embodiment in FIG. 4, in such a way that the light 1503, 1507 from the pixels 1501, 1505 may respectively be converged and deflected by the optical modules 1502, 1506 with the same function as shown in FIG. 4.

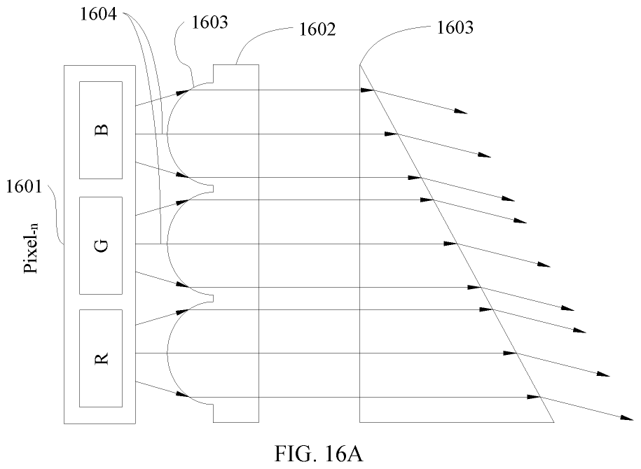

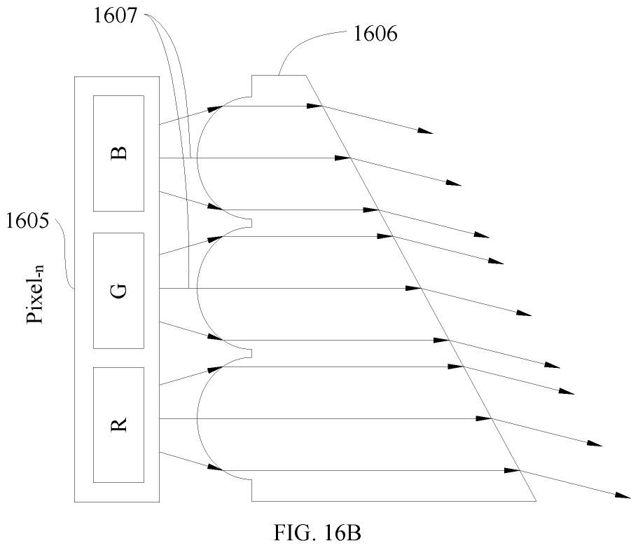

Please refer to FIG. 16A. As shown in the figure, the collimation unit is located at one side of one of the pixels, the collimation unit 1602 has a first side and a second side relative to each other, the first side faces the display panel, the first side has a plurality of convex parts 1603 protruding to the display panel, the plurality of convex parts 1603 respectively correspond to a plurality of sub-pixels of the pixels 1601, and the second side is a flat surface. Further, a pixel is usually formed of a plurality of sub-pixels, such as red, green, and blue sub-pixels. The number of convex lenses may be increased for one pixel to obtain finer collimated image light. In the present embodiment, the collimation unit 1602 may have three convex parts (convex lenses) 1603, and each of the convex parts 1603 corresponds to each of the sub-pixels in the pixel 1601, so as to converge the light 1604 from each of the sub-pixels into collimated image light. The collimated image light is then received by the refraction unit 1603 and further deflected (refracted) before being emitted.

Please refer to FIG. 16B. As shown in the figure, in the present embodiment, it is substantially the same as or similar to the embodiments as mentioned above; the main difference is that the collimation unit and one of the refraction units are integrated into an integrally-formed optical module 1606. In the present embodiment, the optical module 1606 may have three convex parts (convex lenses), and each of the convex parts corresponds to each of the sub-pixels in the pixel 1605, so as to converge the light 1607 of each of the sub-pixels into collimated image light, which is then further deflected (refracted) before being emitted.

The present disclosure provides an autostereoscopic display method, including: providing a display panel, the display panel having a plurality of pixel groups, each of the pixel groups including a plurality of pixels, and all of the pixels being arranged in an array; controlling the pixels to emit corresponding image light according to coordinate information and depth information of an object in an image; disposing a plurality of collimation units on one side of the display panel to receive the image light and converge the image light into collimated image light and then emit the collimated image light along the light-emitting direction, and each of the collimation units being located on one side of at least one of the pixels; and disposing a plurality of refraction units on one side of the plurality of collimation units relative to the display panel, so as to receive the collimated image light and refract the collimated image light into refraction image light, which is then emitted along the light-emitting direction, and each of the refraction units being located in front of at least one of the pixels on two sides of a center of the pixel group; wherein light beams of the refraction image light on two sides of the center of the pixel group are projecting in symmetrically increased oblique angles with respect to the center of the pixel group.

The method further includes: obtaining the coordinate information and the depth information corresponding to the object in the image according to the oblique angles of the light beams of the refraction image light of each of the pixels.

It should be noted that, regarding the autostereoscopic display method of the present disclosure, the detailed implementation corresponds to the autostereoscopic display device as mentioned above, so similar descriptions are not to be described herein.

As described above, according to the autostereoscopic display device and method of the present invention, when the image light is emitted along the light-emitting direction through the display panel, the image light can be collected into a collimated image light by a plurality of collimating units, and then refracting the collimated image light into refraction image light by the refraction unit, and emits the light along the dedicated direction, which allows the viewer to see a stereoscopic image in virtual reality without being restricted to a limited visual field. Therefore the autostereoscopic display effect is enhanced, and the user experience may be improved.

The above description is merely illustrative rather than restrictive. Any equivalent modifications or alterations without departing from the spirit and scope of the present disclosure are intended to be included in the following claims.

1 What is claimed is:

1. An autostereoscopic display device, in sequence along a light-emitting direction, comprising:
a display panel, having a plurality of pixel groups, each of the pixel groups comprising a plurality of pixels, all of the pixels being arranged in an array, and the display panel emitting image light in the light-emitting direction;
a plurality of collimation units, each of the collimation units being located at one side of one of the pixels to receive the image light, and each of the collimation units converging the image light into collimated image light, and then emitting the collimated image light along the light-emitting direction; and
a plurality of refraction units, each of the refraction units being located in front of at least one of the pixels on two sides of a center of the pixel group, so as to receive the collimated image light; the refraction unit refracting the collimated image light into refraction image light, and then emitting the refraction image light along the light-emitting direction;
wherein light beams of the refraction image light on two sides of the center of the pixel group are projecting in symmetrically increased oblique angles with respect to the center of the pixel group.

2. The autostereoscopic display device according to claim 1, wherein the light beams of the refraction image light on two sides of the center of the pixel group are symmetrically and obliquely diffused.

3. The autostereoscopic display device according to claim 1, wherein the refraction unit has an incident light surface and an emergent light surface, the incident light surface is a flat surface, is parallel to the display panel, and faces the display panel, and the emergent light surface is an inclined surface relative to the display panel.

4. The autostereoscopic display device according to claim 3, wherein the collimation unit is a convex lens, the collimation unit has a first side and a second side relative to each other, the first side faces the display panel, the first side is a convex surface, and the second side is a flat surface.

5. The autostereoscopic display device according to claim 3, wherein the collimation unit is located at one side of one of the pixels, the collimation unit has a first side and a second side relative to each other, the first side faces the display panel, the first side has a plurality of convex parts protruding to the display panel, the plurality of convex parts respectively correspond to a plurality of sub-pixels of the pixels, and the second side is a flat surface.

6. The autostereoscopic display device according to claim 4, wherein the emergent light surface of the refraction unit on two sides of the center of the pixel group is disposed in a relatively oblique manner.

7. The autostereoscopic display device according to claim 4, wherein the center of the pixel group has a normal line, and an included angle between the inclined surface and the normal line is gradually reduced from the center of the pixel group to two sides of the center of the pixel group.

8. The autostereoscopic display device according to claim 4, wherein one of the collimation units and one of the refraction units are integrated into an integrally-formed module.

9. The autostereoscopic display device according to claim 5, wherein the emergent light surface of the refraction unit on two sides of the center of the pixel group is disposed in a relatively oblique manner.

10. The autostereoscopic display device according to claim 5, wherein the center of the pixel group has a normal line, and an included angle between the inclined surface and the normal line is gradually reduced from the center of the pixel group to two sides of the center of the pixel group.

11. The autostereoscopic display device according to or claim 5, wherein one of the collimation units and one of the refraction units are integrated into an integrally-formed module.

12. An autostereoscopic display method, comprising:
providing a display panel, the display panel having a plurality of pixel groups, each of the pixel groups comprising a plurality of pixels, and all of the pixels being arranged in an array;
controlling the pixels to emit corresponding image light according to coordinate information and depth information of an object in an image;
disposing a plurality of collimation units on one side of the display panel to receive the image light and converge the image light into collimated image light and then emit the collimated image light along the light-emitting direction, and each of the collimation units being located on one side of at least one of the pixels; and
disposing a plurality of refraction units on one side of the plurality of collimation units relative to the display panel, so as to receive the collimated image light and refract the collimated image light into refraction image light, which is then emitted along the light-emitting direction, and each of the refraction units being located in front of at least one of the pixels on two sides of a center of the pixel group;
wherein light beams of the refraction image light on two sides of the center of the pixel group are projecting in symmetrically increased oblique angles with respect to the center of the pixel group.

13. The autostereoscopic display method according to claim 12, wherein the light beams of the refraction image light on two sides of the center of the pixel group are symmetrically and obliquely diffused.

14. The autostereoscopic display method according to claim 12, further comprising:
disposing an incident light surface of the refraction unit to be a flat surface, be parallel to the display panel, and face the display panel;
disposing an emergent light surface of the refraction unit to be an inclined surface relative to the display panel; and
disposing the emergent light surface of the refraction unit on two sides of the center of the pixel group in a relatively oblique manner.

15. The autostereoscopic display method according to claim 14, further comprising:
disposing a convex lens to be the collimation unit, and the collimation unit having a first side and a second side relative to each other; and
making the first side face the display panel, wherein the first side is a convex surface, and the second side is a flat surface.

16. The autostereoscopic display method according to claim 14, further comprising:
disposing one of the collimation units to be located on one side of one of the pixels, and the collimation unit having a first side and a second side relative to each other; and
making the first side face the display panel, wherein the first side has a plurality of convex parts protruding to the display panel, each of the convex parts corresponds to a plurality of sub-pixels of one of the pixels, and the second side is a flat surface.

17. The autostereoscopic display method according to claim 15, wherein the center of the pixel group has a normal line, and an included angle between the inclined surface and the normal line is gradually reduced from the center of the pixel group to two sides of the center of the pixel group.

18. The autostereoscopic display method according to claim 15, wherein one of the collimation units and one of the refraction units are integrated into an integrally-formed module.

19. The autostereoscopic display method according to claim 16, wherein the center of the pixel group has a normal line, and an included angle between the inclined surface and the normal line is gradually reduced from the center of the pixel group to two sides of the center of the pixel group.

20. The autostereoscopic display method according to claim 16, wherein one of the collimation units and one of the refraction units are integrated into an integrally-formed module.

21. The autostereoscopic display method according to claim 12, further comprising:
obtaining the coordinate information and the depth information corresponding to the object in the image according to the oblique angles of the light beams of the refraction image light of each of the pixels.
